(19) United States
(12) Patent Application Publication
(10) Pub. No.: US 2021/0267393 A1
(43) Pub. Date: Sep. 2, 2021

(54) Compartment Technology for Lids of Beverage Container

(71) Applicant: Michael Rechsteiner, Laguna Hills, CA (US)

(72) Inventor: Michael Rechsteiner, Laguna Hills, CA (US)

(21) Appl. No.: 16/805,694

(22) Filed: Feb. 28, 2020

(51) Int. Cl. A47G 19/22

(52) U.S. Cl. CPC A47G 19/2272

(57) ABSTRACT

A mug cap apparatus comprises a mug cap and a mug. The mug cap comprises a base cylindrical body having a hollow opening in the center. The base cylindrical body has a narrow portion and a wide portion. A sealer ring seals the base cylindrical body to the mug. The wider portion engages the rim of the mug and the narrow portion engages the inner perimeter portion of the mug. The hollow opening has threads to engage a compartment's cylindrical body. The compartment's cylindrical body has an outer perimeter that has threads to engage the threads of the base cylindrical body, and an inner compartment. A lid engages said compartment cylindrical body and seals said inner compartment when said lid is in its closed configuration.

### FIELD OF THE INVENTION

The present invention relates to beverage containers, and, more specifically, to making a mug cap with a convenient compartment to store small things such as teabags, lose leaf tea, protein powder, etc.

### BACKGROUND OF THE INVENTION

As people get busier, they do not have time for brewing a perfect cup of coffee or tea notwithstanding a brewing pot that conveniently separates the brew waste and the brew. Furthermore, they also want to keep their beverages warmer longer so they can get the best tastes. These desires have been met with a variety of mugs, that insulates the beverage inside from the temperature outside, and has become a modern convenience that busy coffee or tea drinkers and commuters cannot function without. The more convenient and functional mugs get, the more often and more people use them. In recent years, among other changes, mug caps are improved substantially and provide more utility.

For example, a mug with a stopper or screw cap that has both an infuser, and an opening for sipping has allowed a coffee or tea drinker to brew her coffee or tea on the go as if the user takes a brewing pot with her. The vacuum mug keeps the hot water hot, so the coffee or tea in the strainer or infuser has time to brew while the user travels to the workplace. With the sipper separate from the strainer or infuser, the user does not have to wait until arriving at the office to enjoy the beverage. She can enjoy the beverage while driving without removing the strainer or infuser.

Among many utility and convenient features mugs and mug caps have, one feature campers, outdoor enthusiasts, or users traveling to areas where brew products or their specialty products are not available like much is an attached compartment to store extra coffee, tea, tea bags, protein powder, or any special brew products. On current market, the attached compartment is usually a cup attached to the bottom of a mug by a variety of attachment methods. Although the compartment provides convenient storage utility, and in certain situations it is extremely helpful, it makes the mug longer or taller than regular mugs. The extra volume and height pose a new challenge or problem; that is, the taller mug does not fit in a POD machine, or a normal slot in a bag, or is obstructive in a user's hand.

Therefore, it is desirable to have a compartment for additional brew products within the mug without making the mug larger than a regular mug.

### OBJECT OF THE INVENTION

Accordingly, it is the object of this invention to create a mug cap that has an accessible compartment independent of other utilities of the cap.

It is the object of this invention to create a mug cap that maintains the temperature of the contained beverage.

It is the object of this invention to create a mug cap that is spill-proof and brew-through capable.

It is an object of the invention to create a mug cap that allows immediate beverage consumption without removing the cap completely.

It is an object of the invention to create a mug with a cap that fits a coffee or tea POD machine.

### SUMMARY OF INVENTION

This invention is directed to a mug cap apparatus comprises a base cylindrical body having a hollow opening in the center. The base cylindrical body has a narrow portion and a wide portion. A sealer ring seals the base cylindrical body to the mug. The wider portion engages the rim of the mug and the narrow portion engages the inner perimeter portion of the mug. The hollow opening has threads to engage a compartment's cylindrical body. The compartment's cylindrical body has an outer perimeter that has threads to engage the threads of the base cylindrical body, and an inner compartment. A lid engages said compartment cylindrical body and seals said inner compartment when said lid is in its closed configuration.

In one embodiment, the mug cap further comprises a compartment cylindrical body that seals the hollow opening of the base cylindrical body when the compartment cylindrical body's thread engages with the thread of the base cylindrical body.

In another embodiment, the mug cap comprises a lid that comprises a ledge for ease of opening.

### BRIEF DESCRIPTION OF THE DRAWINGS

These and other features and advantages of the invention will not be described with reference to the drawings of certain preferred embodiments, which are intended to illustrate and not to limit the invention, and in which

FIG. 1 is a perspective view of a mug cap being fully assembled and in a closed position.

FIG. 2 is a perspective view of a mug cap with its compartment's lid opened.

FIG. 3 is a side view of a mug cap with its compartment removed and shown.

### DETAILED DESCRIPTION OF THE INVENTION

Some embodiments are described in detail with reference to the related drawings. Additional embodiments, features, and/or advantages will become apparent from the ensuing description or may be learned by practicing the invention. The following description is not to be taken in a limiting sense, but is made merely for the purpose of describing the general principles of the invention. The steps described herein for performing methods form one embodiment of the invention, and, unless otherwise indicated, not all of the steps must necessarily be performed to practice the invention, nor must the steps necessarily be performed in the order listed. It should be noted that references to “an” or “one” or “some” embodiment(s) in this disclosure are not necessarily to the same embodiment, and such references mean at least one.

The present invention has been conceived with the aim of addressing one or more of the current mug caps' limitations. More specifically, the present invention is directed to a mug cap that provides a convenient accessory compartment disposed in the hollow center of the mug cap.

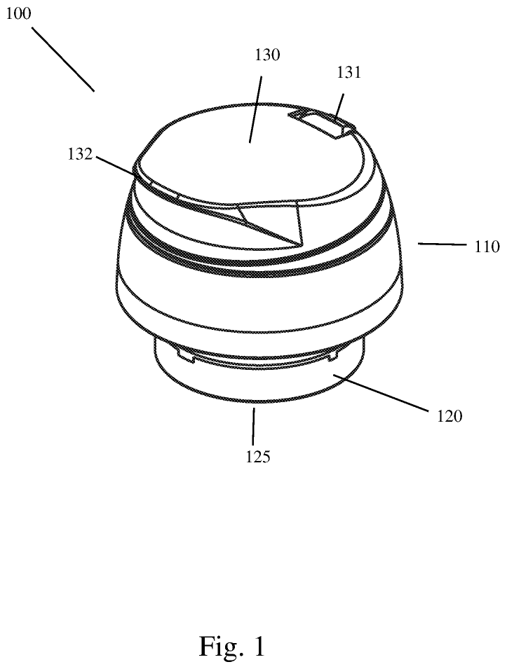

Referring to FIG. 1, in this embodiment, a cap 100 is shown, closed and sealed. The cap is structured with an upper half of a hollow prolate spheroid 110 that has a flat top dome, disposing on top of a cylindrical segment base 120. The lower cylindrical segment has a smaller diameter than the circular bottom of the semi prolate spheroid 110. The cylindrical segment base 120 is male threaded on the outer wall. This thread will mate with the female thread on the inner wall of a tumbler's neck. The lower segment further comprises a hollow opening 125 in the center. When the cap screws into the tumbler, and closes it, a sealer ring, usually made of silicone, is disposed between the rim of the tumbler and the underside of the semi prolate spheroid 110. The sealer ring seals any gaps between the underside of the semi prolate spheroid 110 and the tumbler's rim. At the top, the top opening is covered by a hinged lid 130, that swings upon a hinge 131. The hinged lid further comprises a protruding tab, or ledge, 132, which is fused with the lid as one component, to assist a user to open the lid. The user could put a thumb on the underside of the protruding tab/ledge, and push the lid up to open it.

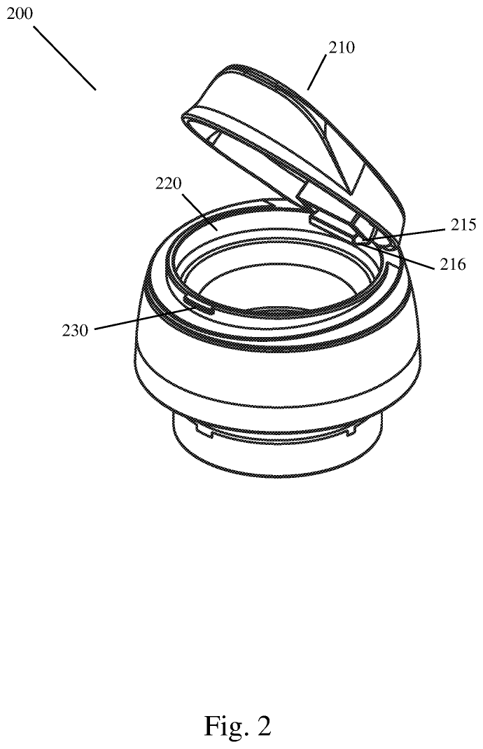

Referring to FIG. 2, in this embodiment, the cap 200 is shown with the hinged lid 210 being pushed up and opened, and the accessory compartment 220 is partially shown. As shown, the hollow of the semi prolate spheroidal cap is the compartment's container. The inside of the compartment comprises several concentric cylindrical walls designed for a variety of purposes. It is also appreciated that the depth of the compartment can be configured to take up the entire depth of the cap. In this embodiment, the lid hinge 215 comprises a general cuboid, disposed about the rim of the compartment 220, which acts as the immobile half of the hinge 215. The lid 110 comprises an U-shape indentation, whose two sides act as the movable half of the hinge 215. The cap further comprises a protruding tab 230 on the outer wall of the compartment's 220 rim, that acts as a latch's catch to keep the lid 210 down once the tab catches the annular rim of the lid.

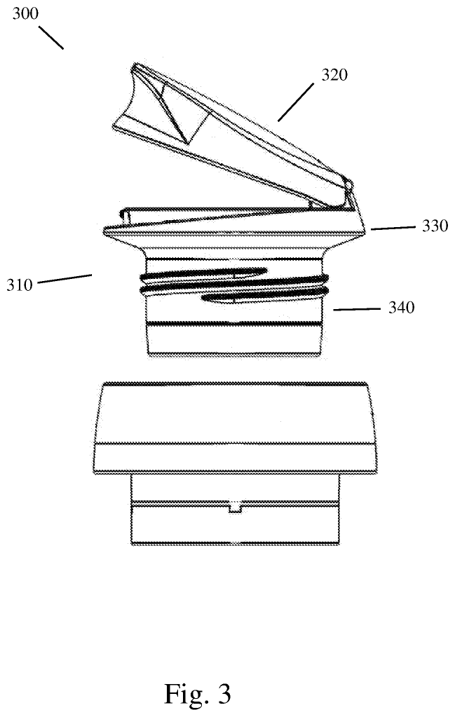

Referring to FIG. 3, a cap 300 is shown with the accessory compartment 310 is removed from the cap, and its hinged lid 320 is pushed up and opened. In this embodiment, the compartment 310, besides the lid 320, further comprises a thick flange-like rim 330 around the opening of a hollow cylindrical segment 340, that is male threaded on the outer wall. This male thread will engage with the female thread on the wall of the cap's hollow. The hollow of the cylindrical segment 340 is the compartment's container. The depth of this container can be configured to meet a variety of design and utility purposes. For instance, in one embodiment, the cap further comprises a sipper opening through and at the bottom of the cap's hollow. In this case, the depth of the compartment must be shallower to accommodate the bottom of the cap's hollow. Furthermore, the flange-like rim 330 must also seal any gaps between the cap's base and the underside of the rim 330 to prevent spillage when the compartment screws in and closes the cap's base. In yet another embodiment, the compartment 310 is adhere to the lower segment without the thread but by magnetic means inside the lower segment and the top compartment 310 is embedded with metal plates. In yet another embodiment, the compartment 310 is adhere to the lower segment, even with the thread, to enhance attachment with magnetic means inside the lower segment and the top compartment 310 is embedded with metal plates.

1. A mug cap apparatus comprising a mug cap and a mug;
said mug having a rim on top of said mug; an outer perimeter portion and an inner perimeter portion;
said mug cap is comprised of a base cylindrical body having a hallow opening in the center; said base cylindrical body having a narrow portion and a wide portion; a sealer ring along the perimeter of said narrow portion; said sealer seals said base cylindrical body to said mug; said wider portion engages the rim of said mug and said narrow portion engages said inner perimeter portion of said mug; said hallow opening having threads to engage a compartment cylindrical body;
said compartment cylindrical body having an outer perimeter and an inner compartment wherein said outer perimeter has threads to engage said threads of said base cylindrical body; a lid engages said compartment cylindrical body and seals said inner compartment when said lid is in its closed configuration.

2. The mug apparatus of claim 1 wherein said compartment cylindrical body seals said hallow opening of said a base cylindrical body when said compartment cylindrical body is engaged via said threads of said base cylindrical body.

3. The mug apparatus of claim 1 wherein said lid further comprise a ledge for ease of opening.
